(19) United States
(12) Patent Application Publication
(10) Pub. No.: US 2019/0112518 A1
(43) Pub. Date: Apr. 18, 2019

(54) METHOD FOR SOLUBILIZING BIOPOLYMER SOLIDS FOR ENHANCED OIL RECOVERY APPLICATIONS

(71) Applicant: CARGILL, INCORPORATED, WAYZATA, MN (US)

(72) Inventors: Timothy Walter ABRAHAM, Minnetonka, MN (US); Eric Stanley SUMNER, Minneapolis, MN (US)

(21) Appl. No.: 16/089,740

(22) PCT Filed: Mar. 28, 2017
(86) PCT No.: PCT/US17/24477

§ 371 Date: Sep. 28, 2018

Related U.S. Application Data
(60) Provisional application No. 62/313,988, filed on Mar. 28, 2016.

(51) Int. Cl. C09K 8/588; C08B 37/00; C08J 3/05

(52) U.S. Cl. CPC C09K 8/588; C08J 3/05; C08B 37/0024

(57) ABSTRACT

Disclosed herein is a method to rapidly solubilize beta glucan (BG) material comprising passing the beta glucan material, in solution, through an in-line high shear system, wherein viscosity of the solubilized beta glucan material is 90% or greater of ultimate viscosity and wherein filterability ratio of the solubilized beta glucan material ranges from about 1-2.

### TECHNICAL FIELD

The present invention relates to the solubilization of a beta glucan material to achieve desirable filterability and viscosity characteristics particularly (but not exclusively) for enhanced oil recovery applications.

### BACKGROUND

Beta glucans are widely used as thickeners in enhanced oil recovery (EOR) applications. Particularly in off-shore applications, there is a desire to utilize such beta glucans, however given the limited amount of real estate it is desirable to receive the beta glucan in solid form, quickly solubilize or resolubilize using the water on hand and minimal equipment, wherein the solubilization/resolubilization procedure provides desirable properties, for example filterability and viscosity, necessary for enhanced oil recovery operations. The major drawback of scleroglucan polymer (a beta glucan) is its poor solubilization. Methods have been investigated and studied in this regard, however each of these methods have presented limitations.

### BRIEF SUMMARY

Disclosed herein is a method to rapidly solubilize beta glucan (BG) material comprising passing the beta glucan material through an in-line high shear system, wherein viscosity of the solubilized beta glucan material is 90% or greater of ultimate viscosity and wherein filterability ratio of the solubilized beta glucan material ranges from about 1-2.

### FIGURES

FIG. 1 illustrates viscosity build of solubilized beta glucan material that does not pass through the in-line shear system described herein.

### DEFINITIONS

“Average Residence Time” is defined as the holdup volume of the shear element divided by the average flow rate through the shear element in seconds.

“Shear Duration” is defined as average residence time (in seconds) in the shear element multiplied by the shear rate (inverse seconds).

“Solid” is defined as a solid (i.e., not a liquid or gas) at standard atmospheric conditions. For the avoidance of doubt, the term “solid” includes powders, pressed or wet cakes, and solids surrounded by an alcohol solution or hydrophobic liquid.

“Solubilized beta glucan material” is defined as the beta glucan material, in solution, obtained once the solubilization procedure is complete.

“Ultimate Viscosity” is defined as the average viscosity on passes 6, 7, and 8 measured at a given shear rate across consecutive multiple passes under the viscosity solubilization procedure.

“Viscosity Build” is defined as the increase in viscosity of the beta glucan material, in solution, as it progresses through the solubilization procedure described herein.

### DETAILED DESCRIPTION

Disclosed herein is a method to rapidly solubilize semi-rigid or rigid EOR biopolymers comprising passing beta glucan material, in solution, through an in-line high shear system to disperse solids therein, wherein the viscosity of the solubilized beta glucan material is 90% or greater of the ultimate viscosity and the filterability ratio of the solubilized beta glucan material ranges from 1-2.

### Beta Glucan Material

The beta glucan (“BG”) material described herein, comprises at least 75 wt % of include polysaccharides classified as 1,3-1,6 beta-D-glucans in solid form. According to aspects herein, the beta glucans comprise a main chain from beta-1,3-glycosidically bonded glucose units, and side groups which are formed from glucose units and are beta-1,6-glycosidically bonded thereto.

Fungal strains which secrete such glucans are known to those skilled in the art. Examples comprise Schizophyllum commune, Sclerotium rolfsii, Sclerotium glucanicum, Monilinla fructigena, Lentinula edodes or Botrygs cinera. The fungal strains used are preferably Schizophyllum commune or Sclerotium rolfsii.

Particularly preferred beta glucans for use herein is “scleroglucan” (or, a branched beta-D-glucan with one out of three glucose molecules of the beta-(1,3)-backbone being linked to a side D-glucose unit by a (1,6)-beta bond produced from, e.g., fungi of the Sclerotium).

Another particularly preferred beta glucan for use herein is “schizophyllan” (a branched BDG having one glucose branch for every third glucose residue in the beta-(1,3)-backbone produced from, e.g., the fungus Schizophyllan commune).

The pH of the beta glucan material ranges from about 5 to about 9 and more preferably from about 6 to about 7.5. The salinity of the beta glucan material is greater than 0.5M of metal cations, wherein the metal cation is Na⁺, Ca²⁺, or Mg²⁺.

The beta glucan material can also be suspended in an alcohol solution or hydrophobic liquid.

### Solubilization Using High Shear System

The method of rapidly solubilizing the beta glucan material includes dispersing the beta glucan material into solution and subjecting the beta glucan material, in solution, to relatively high shear using an in-line high shear system. The equipment utilized in this procedure is suitable for off shore EOR applications.

To begin solubilization of the beta glucan material it is put into solution at a concentration ranging from about 0.1 g/L to about 10 g/L. Solubilization of the beta glucan material can be carried out in either salt water or fresh water, in pH conditions ranging from about 6 to about 7.5, and in temperature conditions ranging from about 10° C. to about 130° C., more specifically from about 20° C. to about 30° C. The beta glucan material can initially be dispersed (incorporating the beta glucan material into a bulk liquid) into salt or fresh water and subjected to gentle mixing (shear rate of less than 40,000/s) for a time period of less than five minutes.

Subsequent to mixing the beta glucan material to disperse it into solution, the beta glucan material is subject to an in-line high shear system. In some aspects, the high shear system comprises at least one high shear element. In other aspects, the high shear system comprises at least two or at least three high shear elements. In aspects wherein there are multiple high shear elements, the shear elements are in series.

The shear in the high shear system can be imparted via many approaches known to one familiar in the art, including moving parts like a rotor-stator pair or a colloidal mixer or static, non-moving part devices like an orifice plate or a narrow tube with high velocity flow. The shear can also be imparted via a device that has adjustable moving parts.

The shear rate in which these shear elements operate ranges from about 40,000/s to 300,000/s, more preferably from about 100,000/s to 250,000/s, and even more preferably from about 170,000/s to 225,000/s. In aspects where there are multiple high shear elements within the in-line high shear system, the rate of the shear can be increased by at least 25% between shear elements. The average residence time in which the beta glucan material is subject to shear is less than ten seconds, in some aspects less than 5 seconds, and in other aspects less than 1 second. Further, the shear duration is less than 250,000.

In some aspects, the overall time from initial shear to final shear completion is less than five minutes and more preferably less than one minute. This overall time includes time spent between shear elements.

The operational temperature within the high shear system ranges from about 10° C. to about 130° C., more specifically from about 20° C. to about 30° C.

To reduce waste of the beta glucan material after passing through the high shear system one time, less than 90 wt % of the beta glucan material can be recycled back through the high shear system, and in preferred aspects, less than 10 wt % of BG material can be recycled back through the high shear system.

To obtain desirable solubilization, the beta glucan material can require 1 to 6 passes through the high shear system. Multiple passes can be required if viscosity continues to rise, with solubilization being complete after an indication of a consistent or slightly dropping viscosity on two consecutive passes.

The beta glucan material described herein has a purity sufficient enough that greater than 50% of ultimate viscosity can be recovered after passing the BG material through the high shear system after one pass and greater than 70% of ultimate viscosity after two passes. In preferred aspects, greater than 60% of ultimate viscosity, greater than 70% of ultimate viscosity, and even greater than 80% of ultimate viscosity is achieved after passing the beta glucan material through the high shear system for one pass. In additional preferred aspects, greater than 80% of ultimate viscosity, and even greater than 90% of ultimate viscosity is achieved after passing the beta glucan material through the high shear system after one pass. In all aspects, however, the viscosity of the completed solubilized beta glucan material is 90% or greater of the ultimate viscosity. The ultimate viscosity as described herein ranges from about 2 cP to about 1000 cP and in preferred aspects ranges from about 50 cP to about 200 cP.

This high shear procedure provides a beta glucan material having a filterability ratio ranging from about 1 to about 2, and in preferred aspects a filterability ratio less than 1.5.

The overall time from the introduction of the beta glucan material into solution to well injection is preferably less than 30 minutes, therefore making it an efficient and quick solubilization process for EOR applications.

### Methods

It shall be understood that the procedures described herein should be carried out at temperatures ranging from 20-30° C. (except otherwise noted).

### Solubilization Procedure

1. Prepare 30 g/l salt water solution, using deionized water and 59883 Sigma-Aldrich sea salts.
2. Use Pall stainless steel filter funnel (4280) to filter salt water through a 0.8 um EMD Millipore filter (AAWP04700) at 100-300 mL/min.
3. After filtering, check pH of salt water. Adjust to 6.3 using HCl or NaOH if outside of 6.2 to 6.4 pH range.
4. On a Fisher Scientific Isotemp mixing plate (S88857290) at 800 rpm sprinkle betaglucan material at target concentration (0.1 to 10 g/L) to wall of vortex and allowed it to stir for 5 minutes.
5. Feed material, in solution, through an in-line high shear system element, documenting the equipment type and operating conditions.
6. Testing on material is done after removing air bubbles from solution, for example by letting sample sit or accelerating the separation with a centrifuge or similar device.
7. Continue running through the in-line high shear system element for a total of 6 passes, collecting any intermediate samples and removing air bubbles before testing.

### Viscosity Solubilization Procedure (to Determine Ultimate Viscosity)

1. Prepare 30 g/l salt water solution, using deionized water and S9883 Sigma-Aldrich sea salts.
2. Use Pall stainless steel filter funnel (4280) to filter salt water through a 0.8 um EMD Millipore filter (AAWP04700) at 100-300 mL/min.
3. After filtering, check pH of salt water. Adjust to 6.3 using HCl or NaOH if outside of 6.2 to 6.4 pH range.
4. On a Fisher Scientific Isotemp mixing plate (S88857290) at 800 rpm sprinkle betaglucan material at target concentration (0.1 to 10 g/L) to wall of vortex and allowed it to stir for 5 minutes.
5. At 10,000 rpm, feed solution through IKA® Magic Lab® Ultra-Turrax® Inline (UTL) module equipped with the 4M generator set.
6. Viscosity was measured after removing air bubbles from solution, for example by letting sample sit or accelerating the separation with a centrifuge or similar device.
7. Continue running for 8 passes, recording the average viscosity of pass 6, 7, and 8 as the solution's ultimate viscosity.

### Filtration Procedure (to Determine Filterability Ratio)

1. Solubilize BG material according to the solubilization procedure above. (note: this filtration procedure should be carried out on the resultant solution before microbes begin to form as microbial growth can negatively impact filtration)
2. If solution concentration is >1 g/L, add water and mix for five minutes on a Fisher Scientific Isotemp mixing plate (S88857290) at 800 rpm. If solution is already <=1 g/L, proceed immediately to next step as-is.
3. Assemble Pall stainless steel filter housing (4280) with a 47 mm, 1 2μm filter, EMD Millipore cellulosic-ester filter (part #RAWP04700), with >200 mL of solution.
4. Place a container on a mass balance for recording mass of material passing through filter.
5. Apply pressure to the filter.
6. Unplug filter and target flux of 1-3 g/s, adjusting pressure as necessary.
7. After establishing flow, maintain constant pressure during filtration.
8. Record time to flow 60 g, 80 g, 160 g, and 180 g of solution through the filter using a mass balance.
9. Calculate filterability ratio using the filterability ratio equation:

$$\frac{Time ( 180 g ) - Time ( 160 g )}{Time ( 80 g ) - Time ( 60 g )}$$

### Viscosity Measurement

1. Viscosity measurements were done on degassed samples using a Brookfield Ametek® LVT (spindle 1, at 6, 12, 30, and 60 rpm) viscometer.

### EXAMPLES

### Example 1: Production of the BG Material Described Herein

Using a 5000 liter jacketed vessel with moderate agitation, 7 g/L of commercial Actigum CS6 from Cargill is added to 2400 liters of 11.8° C. water and mixed for 1 hour. After an hour of mixing, the vessel is heated to 85° C. and left under agitation for 12 hours without temperature control. After 12 hours the temperature is 41.3° C. and the vessel is reheated to 80° C. and passed through a Guerin homogenizer (ALM6; Series B 8250 30 000; Year 1998) at 200 bar of pressure and 300 l/hr.

The homogenized mixture is cooled to 50° C. 4 g/L of CaCl₂*2H₂O was added. pH is reduced to 1.81 using 20% HCl. This mixture is agitated for 30 minutes to enable precipitation of oxalic acid.

After maturation, the solution is adjusted back to 5.62 pH using 10% Na₂CO₃ and heated to 85° C. and left under agitation without temperature control for 14 hours the reheated to 80° C.

After reaching 80° C. 20 g/L of Dicalite 4158 filter aid is added to the vessel and mixed for 10 minutes.

After mixing, the solution is fed to a clean Choquenet 12 m² press filter with Sefar Fyltris 25080 AM filter clothes at 1400 L/hr recycling the product back to the feed tank for 10 minutes. At the end of recycle, the flow is adjusted to 1300 L/hr and passed through the filter. Once the tank is empty an additional 50 liters of water is pushed into the filter. The fluid from this water flush and a 12 bar compression of the cake is both added to the collected permeate. The filter is cleaned after use.

The filtered permeate, water flush, and compression fluid is agitated and heated back to 80° C.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1400 L/hr.

Without cleaning the filter, 5.33 g/L of Clarcel ® DICS and 6.667 g/L of Clarcel® CBL is added to the mixture and agitated for one hour while maintaining temperature at 80° C. This mixture is then recycled through the Dicalite coated Choquenet 12 m² press filter with Sefar Fyltris 25080 AM filter clothes at 1400 L/hr for 15 minutes. After the recycle, the tank is passed through the filter at 1350 L/hr. An additional 50 liters of flush water is pushed through the filter and collected as permeate as well. Compression fluid from the filter is not captured.

This twice filtered material is heated to 85° C. and left agitated without temperature control for 14 hours. At this point the material is reheated to 80° C. for a third filtration step.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1450 L/hr.

Without cleaning the filter, 5.33 g/L of Clarcel ® DICS and 6.667 g/L of Clarcel® CBL is added to the mixture and agitated for one hour while maintaining temperature at 80° C. This mixture is then recycled through the Dicalite coated Choquenet 12 m² press filter with Sefar Fyltris 25080 AM filter clothes at 1600 L/hr for 15 minutes. After the recycle, the tank is passed through the filter at 1700 L/hr. An additional 50 liters of flush water is pushed through the filter and collected as permeate as well. Compression fluid from the filter is not captured.

The triple filtered permeate is cooled to 60° C. and mixed with 83% IPA at a 1:2 ratio, 2 g IPA solution for each g of scleroglucan solution. This precipitates scleroglucan fibers which can be mechanically separated from the bulk solution. In this example, a tromel separator is used to partition the precipitated fibers from the bulk liquid solution.

After recovery of the fibers they are washed with another 0.5 g 83% IPA solution for each 1 g of initial triple filtered permeate scleroglucan solution.

Wash fibers are dried in an ECI dryer (Volume 100 litres; Type 911-10; Year 1987) with 95° C. hot water for 1 hour and 13 minutes to produce a product with 89.3% dry matter. This material is ground up and sieved to provide powder smaller in size than 250 micron. This final ground scleroglucan material is the novel BG material described herein and used for testing in the identified examples.

### Example 2: Viscosity Build with Static Shear Equipment

Using the solubilization procedure, put 1 g/L of the BG material described herein (see Example 1 for process description) in 3 L of solution. After mixing, add solution to API RP63, section 6.6.2 shear apparatus equipped with a 1/16″ diameter, 20 cm long capillary tube. Push material through capillary at 180 psig (measured flow and shear in Table 1) and discard residual liquid in feed pot. Refill pot and push through again 5 more times, discarding residual liquid and setting aside 300 mL for viscosity testing each pass.

For each of the 6 passes, measure viscosity. As demonstrated, the desired viscosity build is achieved.

TABLE 1
Shear Rate Measurement

| | Pot | Mass | Pass | Flow | Shear |
|---|---|---|---|---|---|
| Pass | Pressure | Passed | Time | Rate | Rate |
| Outlet | (psig) | (g) | (s) | (g/s) | (1/s) |
| 1st | 180 | 2,870 | 86.5 | 33.2 | 164,989 |
| 2nd | 180 | 2,460 | 69.5 | 35.4 | 176,011 |
| 3rd | 180 | 2,103 | 59.5 | 35.3 | 175,715 |
| 4th | 180 | 1,742 | 49.5 | 35.2 | 174,998 |
| 5th | 180 | 1,403 | 40 | 35.1 | 174,416 |
| 6th | 180 | 1,090 | 31 | 35.1 | 174,765 |

TABLE 2
Viscosity Build

| | | Viscosity | Viscosity | Viscosity |
|---|---|---|---|---|
| | | Build | Build | Build |
| | Average | Measured on | Measured on | Measured on |
| Pass | Viscosity | Brookfield | Brookfield | Brookfield |
| Outlet | Build | @12 rpm | @30 rpm | @60 rpm |
| Feed | 6% | 3% | 5% | 10% |
| 1st | 31% | 25% | 31% | 38% |
| 2nd | 80% | 74% | 80% | 85% |
| 3rd | 91% | 87% | 93% | 93% |
| 4th | 94% | 90% | 95% | 98% |
| 5th | 95% | 90% | 95% | 100% |
| 6th | 101% | 96% | 102% | 105% |

### Example 3: Ultimate Viscosity on BG Material Described Herein

Using the viscosity solubilization procedure, put 1 g/L of the BG material described herein (see Example 1 for process description) in 3L of solution. After mixing, add solution to IKA® Magic Lab® in UTL configuration with a 4M rotor stator pair running unit at 10,000 rpm. After each pass centrifuge solution and measure viscosity on Brookfield LVT. Repeat processing through Magic Lab and sampling for viscosity a total of 8 times, or 8 passes. Table 4 provides the results of the viscosity build. The average of passes 6, 7, and 8 achieves the ultimate viscosity.

Based on rotor geometry and 10,000 rpm the system shear is around 105,000 s⁻¹.

TABLE 4
Ultimate Viscosity determination

| | 6 | 12 | 30 | 60 |
|---|---|---|---|---|
| Solution | RPM | RPM | RPM | RPM |
| Feed | 0 | 2.5 | 4 | 3 |
| 1st pass | 45 | 40 | 30 | 21.5 |
| 2nd pass | 85 | 70 | 48 | 33.5 |
| 3rd pass | 90 | 77.5 | 52 | 36.5 |
| 4th pass | 95 | 80 | 53 | 37 |
| 5th pass | 95 | 80 | 54 | 37.5 |
| 6th pass | 95 | 80 | 55 | 38 |
| 7th pass | 95 | 80 | 55 | 38 |
| 8th pass | 95 | 82.5 | 55 | 38.5 |
| Ultimate | 95.0 | 80.8 | 55.0 | 38.2 |
| Viscosity | | | | |

### Example 4: Viscosity Build and Filterability with Dynamic Shear Equipment

Using the solubilization procedure, put 1 g/L of the BG material described herein (see Example 1 for process description) in 3L of solution. After mixing, add solution to IKA® Magic Lab® in UTL configuration with a 4M rotor stator pair running unit at 26,000 rpm. After each pass, centrifuge solution and measure viscosity on Brookfield LVT. Set aside 220 mL for filterability testing. Repeat processing through Magic Lab and sampling for viscosity a total of 6 passes. Table 5 provides the results of the viscosity build and Table 6 shows filterability ratio for the solution.

Based on rotor geometry and 26,000 rpm the system shear is around 270,000 s⁻¹.

TABLE 5
Viscosity Build

| | | Viscosity | Viscosity | Viscosity |
|---|---|---|---|---|
| | | Build | Build | Build |
| | Average | Measured on | Measured on | Measured on |
| | Viscosity | Brookfield | Brookfield | Brookfield |
| Solution | Build | @12 rpm | @30 rpm | @60 rpm |
| Feed | 9% | 3% | 9% | 14% |
| Pass 1 | 58% | 49% | 58% | 66% |
| Pass 2 | 85% | 77% | 87% | 92% |
| Pass 3 | 98% | 93% | 98% | 102% |
| Pass 4 | 94% | 87% | 95% | 100% |
| Pass 5 | 91% | 84% | 93% | 98% |
| Pass 6 | 88% | 77% | 89% | 97% |

TABLE 6
Filterability Ratio

| | Filterability |
|---|---|
| Pass Outlet | Ratio |
| Pass 1 | 2.52 |
| Pass 2 | 1.91 |
| Pass 3 | 1.23 |
| Pass 4 | 1.19 |
| Pass 5 | 1.15 |
| Pass 6 | 1.31 |

### Example 5: Viscosity and Filterability Build with Dynamic Shear Equipment (Beta Glucan Suspension)

Prepare a solution of 90% butanol, 10% deionized water, by weight. Weigh butanol and water, combine and agitate on a stir plate.

Use 90% butanol/10% water solution to mix suspension of 35% beta glucan material. Weigh butanol/water solution and <250 um particle size beta glucan material (from Example 1) in proportions to achieve 35% suspension. Add beta glucan to the butanol/water solution and stir by hand until all solid appears wetted and well incorporated.

Prepare synthetic sea water solution using deionized water and Sigma Aldrich Sea salts (S9883) at 30 g/l salt. Agitate water on a stir plate, add sea salts, allow to agitate until no solids are visible. Filter salt water through a 0.8 um EMD Millipore Mixed Cellulose Ester filter.

Weigh appropriate synthetic sea water to produce a final beta glucan concentration of 1 g/l. Agitate synthetic sea water on a stir plate, add 35% beta glucan suspension. Allow solution to agitate until the there are no visible clumps or phase separation.

After mixing on stir plate, feed solution to IKA® Magic Lab® in UTL configuration with 3 medium rotor stators running unit at 20,000 rpm. IKA® Magic Lab® is an inline mixer using rotor stator to impart shear on the solution. The term ‘pass’ is used to denote feeding solution to the Magic Lab and collecting it at the discharge. One ‘pass’ means solution has been processed through the equipment one time. Solution was processed through Magic Lab for 4 passes, through the 3 rotor stator assembly each pass. This results in the solution effectively seeing 12 rotor stator passes. Viscosity is measured after each pass through the equipment.

To measure viscosity, allow sample to settle or use centrifuge to expedite settling. Solution should have minimal bubbles before measuring viscosity. Viscosity was measured using a Brookfield LVT viscometer at 30 rpm and 21-23° C. Viscosity and filterability results are listed in Table 7.

TABLE 7
Viscosity and Filterability

| | Viscosity | Filterability |
|---|---|---|
| | (cP) | Ratio |
| Magic Lab Pass 1 | 52 | 1.11 |
| (3 Effective) | | |
| Magic Lab Pass 2 | 59 | 1.08 |
| (6 Effective) | | |
| Magic Lab Pass 3 | 62 | 1.10 |
| (9 Effective) | | |
| Magic Lab Pass 4 | 66 | 1.12 |
| (12 Effective) | | |

### Example 6: Viscosity and Filterability using Mixing Stir Plate (Beta Glucan Suspension)

Prepare a solution of 90% butanol, 10% deionized water, by weight. Weigh butanol and water, combine and agitate on a stir plate.

Use 90% butanol/10% water solution to mix suspension of 35% beta glucan material (from Example 1). Weigh butanol/water solution and beta glucan material in proportions to achieve 35% suspension. Add beta glucan to the butanol/water solution and stir by hand until all solid appears wetted and well incorporated.

Prepare synthetic sea water solution using deionized water and Sigma Aldrich Sea salts (S9883) at 35 g/l salt. Agitate water on a stir plate, add sea salts, allow to agitate until no solids are visible. Filter salt water through a 0.8 um EMD Millipore Mixed Cellulose Ester filter.

Weigh appropriate synthetic sea water to produce a final beta glucan concentration of 1 g/l. Agitate synthetic sea water on a stir plate, add 35% beta glucan suspension.

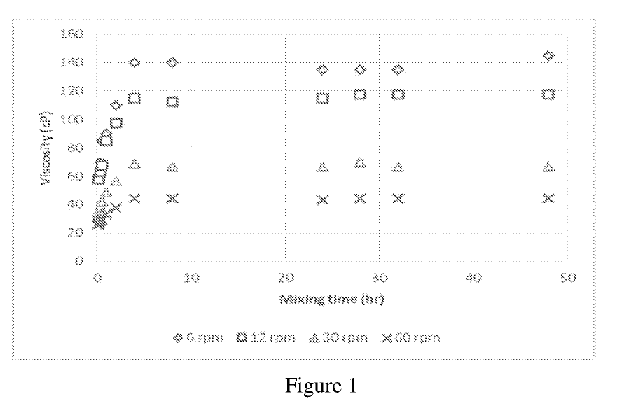

Allow solution to agitate at high speed with vortex for an hour. After an hour, reduce the speed on the stir plate to approximately have the rpm. Continue to mix, and measure solution viscosity over time. To measure viscosity, allow sample to settle or use centrifuge to expedite settling. Solution should have minimal bubbles before measuring viscosity. Viscosity was measured using a Brookfield LVT viscometer at 6, 12, 30 and 60 rpm and 21-23° C. The results are illustrated in FIG. 1 and as illustrated, viscosity build over time falls outside desired range. Furthermore, the filterability ratio is 2.15 and falls outside the desired range.

### Example 7: Viscosity and Filterability using Low Shear Rate

Prepare synthetic sea water solution using deionized water and Sigma Aldrich Sea salts (S9883) at 30 g/l salt. Agitate water on a stir plate, add sea salts, allow to agitate until no solids are visible. Filter salt water through a 0.8 um EMD Millipore Mixed Cellulose Ester filter.

Assemble apparatus according to American Petroleum Institute (API) Recommended Practice (RP) 63, 6.6.2 Capillary Shear Test. Use 0.05″ diameter, 20 cm long capillary tube.

Prepare 3.5 kg of solution. Weigh appropriate synthetic sea water and polymer to produce a final beta glucan material concentration of 1 g/l (using beta glucan material from Example 1). Agitate synthetic sea water on a stir plate to form a vortex. Slowly sprinkle the beta glucan material into the shoulder of the vortex, over 2 to 3 minutes, taking care to avoid creating any clumps. Allow to agitate on stir plate for 5 minutes.

Add beta glucan material, in solution, to the McMaster-Carr 41705K39 tank. Seal tank and pressurize to desired pressure (according to Table 8). Open valve on discharge of tank, and measure the flow rate of beta glucan solution as it flows out of the tank. Use equation from API RP 63, 6.6.2.3 to calculate the shear rate as the solution passes through the capillary. ‘Pass’ listed in Error! Reference source not found. refers to the number of times this process is repeated at the given pressure. For example, the 10 psi/30,000 s-1 sample was added to the tank, pressurized, and passed through the capillary 6 times. ‘Sample’ listed in Table 8 outlines the process order. That is, the sample was processed for 6 passes at 30,000 s-1 shear, viscosity and filterability were measured. Then it was processed for 2 passes at 65,000 s-1 shear, viscosity and filterability measured again, and so on. Viscosity and filterability are also given in Table 8. Viscosity was measured using a Brookfield LVT viscometer at 30 rpm and 21-23° C.

The filterability ratio at different shear rates confirms the need for >40,000 s-1 to achieve a desirable injectable solubilized beta glucan. In particular, at the lower shear rate of 30,000 s-1 the solution was run through the equipment 6 times and still had a poor filterability ratio and lower viscosity than with higher shear rates.

TABLE 8

| | Pressure | Shear | | Viscosity | Filterability |
|---|---|---|---|---|---|
| Sample # | (psi) | (s−1) | Pass | (cP) | Ratio |
| 1 | 10 | 30,000 | 6 | 28 | 2.74 |
| 2 | 30 | 65,000 | 2 | 36 | 1.56 |
| 3 | 50 | 90,000 | 2 | 34 | 1.48 |
| 4 | 80 | 114,000 | 2 | 34 | 1.27 |
| 5 | 120 | 140,000 | 2 | 32 | 1.32 |
| 6 | 180 | 168,000 | 2 | 30 | 1.29 |

What is claimed is:

1. A method to rapidly solubilize beta glucan material for EOR applications, comprising passing the beta glucan material, in solution, through an in-line high shear system, wherein viscosity of the solubilized beta glucan material is at least 90% of ultimate viscosity.

2. The method of claim 1 further comprising mixing the beta glucan material with water under a shear rate less than 40,000/s for less than 5 minutes prior to passing the beta glucan material through the in-line high shear system.

3. The method of claim 1 wherein the in-line high shear system comprises at least one shear element.

4. The method of claim 1 wherein the in-line high shear system comprises at least two shear elements.

5. The method of claim 4 wherein the at least two shear elements are in series.

6. The method of claim 1 wherein the in-line high shear system comprises at least three shear elements.

7. The method of claim 6 wherein the at least three shear elements are in series.

8. The method of claim 6 wherein the shear elements each have a shear rate ranging from 40,000/s to 300,000/s.

9. (canceled)

10. The method of claim 6 wherein the shear elements each have a shear rate ranging from 170,000/s to 225,000/s.

11. (canceled)

12. (canceled)

13. The method of claim 1 wherein pH of the beta glucan material ranges from 6-7.5.

14. The method of claim 1 wherein concentration of the beta glucan material is >0.1 g/L and <10 g/L of beta-glucan.

15.-19. (canceled)

20. The method of claim 1 wherein salinity of the beta glucan material is >0.5M of metal cations.

21. The method of claim 20 wherein the metal cation is Na⁺, Ca²⁺, or Mg ²⁺ or combinations thereof.

22. (canceled)

23. (canceled)

24. The method of claim 1 wherein the average residence time in which the beta glucan material is subject to shear in the high shear system is less than 1 second

25. (canceled)

26. The method of claim 1 wherein the ultimate viscosity at 30 rpm is greater than 2 cP and less than 1000 cP.

27.-36. (canceled)
